(19) United States
(12) Patent Application Publication
(10) Pub. No.: US 2024/0087274 A1
(43) Pub. Date: Mar. 14, 2024

(54) SIMULATION OF THREE-DIMENSIONAL FABRIC DRAPING USING MACHINE LEARNING MODEL

(71) Applicant: CLO Virtual Fashion Inc., Seoul (KR)

(72) Inventors: Eun Jung JU, Seoul (KR); Myung Geol CHOI, Seoul (KR); Eungjune SHIM, Seoul (KR)

(21) Appl. No.: 18/518,540

(22) Filed: Nov. 23, 2023

Related U.S. Application Data
(63) Continuation-in-part of application No. PCT/KR2022/020754, filed on Dec. 19, 2022.

(30) Foreign Application Priority Data
Dec. 17, 2021 (KR) 10-2021-0181947
Dec. 19, 2022 (KR) 10-2022-0178381

(51) Int. Cl. G06T 19/20; G06N 3/0475; G06T 17/20

(52) U.S. Cl. CPC G06T 19/20; G06N 3/0475; G06T 17/20; G06F 3/04842; G06T 2210/36

(57) ABSTRACT

Simulating draping of a 3-dimensional (3D) fabric by providing user input representing physical property parameters of a fabric through a graphical user interface. Once the physical property parameters are received, a 3D shape of fabric is generated by applying the physical property parameters to a neural network.

### CROSS-REFERENCE TO RELATED APPLICATIONS

This application is a bypass continuation-in-part of International PCT Application No. PCT/KR2022/020754, filed on Dec. 19, 2022, which claims priority to Republic of Korea Patent Application No. 10-2021-0181947, filed on Dec. 17, 2021, and Republic of Korea Patent Application No. 10-2022-0178381, filed on Dec. 19, 2022, which are incorporated by reference herein in their entirety.

### TECHNICAL FIELD

The following embodiments relate to a method and devices for a 3-dimensional (3D) fabric draping simulation.

### BACKGROUND ART

A garment appears in three dimensions when worn on a person's body, but it is more in two dimensions because it is actually a combination of pieces of fabric cut according to a two-dimensional (2D) pattern. Since fabric for a garment is flexible, it may vary in appearance from moment to moment according to a body shape or motion of a person who wears it. For example, a garment worn on a human body may slip down or become wrinkled and folded by gravity, wind, or collisions with the body.

A 3D garment simulation may be performed to simulate physical properties of fabric. It is desirable to perform a draping simulation to yield a result that is as close as possible to the actual shape of the fabric. However, relationships between physical property parameters and changes in the shape of draped 3D fabric are largely nonlinear and not intuitive. Accordingly, even for a design expert, finding the physical property parameter for simulating the fabric may be difficult.

Therefore, a process of tuning physical property parameters to result in a close simulation of draping of may be performed to find the desired draping simulation result that is as similar as possible to the actual shape of the fabric. There is growing interest in a user interface that facilitates the user to tune physical property parameters and machine learning technology for accurately and expeditiously generating a draping simulation result corresponding to physical property parameters as they are adjusted.

### SUMMARY

Embodiments relate to a method of simulating draping of fabric. User interface elements configured to indicate physical property parameters of the fabric are displayed. Adjustment to at least a subset of the physical property parameters is received. The adjustment is determined by manipulation of the user interface elements by a user. A mesh of the fabric draped on an object is generated by applying the adjusted physical property parameters to a machine learning model trained using shapes of fabrics draped on the object and physical property parameters of the draped fabrics. The fabric draped on the object according to the generated mesh is displayed.

In one or more embodiments, the machine learning model is a neural network model.

In one or more embodiments, the mesh of the fabric is generated by determining a contour of the fabric by applying the adjusted physical property parameters to the machine learning model, and configuring the mesh of fabric to extend to the determined contour of fabric.

In one or more embodiments, the mesh of the fabric is generated further by generating a first portion of the mesh on an upper surface of the object, generating a second portion of the mesh extending from the first portion of the mesh by a predetermined width, and generating a third portion of the mesh extending from the second portion of the mesh to the contour.

In one or more embodiments, correlation between the physical property parameters is stored. The adjustment to the at least the subset of the physical property parameters is constrained by the stored correlation.

In one or more embodiments, the stored correlation represents distribution of physical property parameters corresponding to the fabric.

In one or more embodiments, the correlation represents reduction in a number of dimensions of the physical property parameters associated with the fabric.

In one or more embodiments, a visual effect indicating violation of constraints on the physical property parameters as indicated by the stored correlation is displayed on the user interface elements responsive to the adjustment violating the constraints.

In one or more embodiments, the visual effect is shown on a pointer of a slide bar corresponding to the physical property parameters.

In one or more embodiments, the adjusted physical property parameters are limited according to the constraints.

In one or more embodiments, the physical property parameters include at least one of a stretch force parameter, a bending force parameter or a density parameter.

In one or more embodiments, the stretch force parameter includes at least one of a weft stretch force parameter, a warp stretch force parameter or a shear force parameter.

In one or more embodiments, the bending force parameter includes at least one of a weft bending force parameter, a warp bending force parameter, and a diagonal bending force parameter.

In one or more embodiments, fabric information is received from the user via the user interface elements. The physical property parameters corresponding to the received fabric information are determined by applying the fabric information to a generative model for generating the physical property parameters.

In one or more embodiments, fabric types are represented on a graph with axes corresponding to a plurality of features. The fabric information is determined according to the graph responsive to receiving a fabric type from the user.

In one or more embodiments, each of the fabric types is represented as a zone defined by ranges of the features indicated by the axes.

In one or more embodiments, a detailed level of the fabric information is generated on the fabric type responsive to receiving a user input indicating selection within the zone.

In one or more embodiments, the fabric information includes at least one of a type of selected fabric, composition information of the selected fabric, and unit weight information of the selected fabric.

In one or more embodiments, the adjusted physical property parameters are sent to a server through a network. The generated mesh is received from the server.

Embodiments also relate to a non-transitory computer-readable storage medium storing instructions thereon. The instructions when executed by a processor cause the processor to display user interface elements configured to indicate physical property parameters of fabric, receive adjustment to at least a subset of the physical property parameters determined by manipulation of the user interface elements by a user, generate a mesh of the fabric draped on an object by applying the adjusted physical property parameters to a machine learning model trained using shapes of fabrics draped on the object and physical property parameters of the draped fabrics, and display the fabric draped on the object according to the generated mesh.

In one or more embodiments, the instructions to generate the mesh of the fabric cause the processor to determine a contour of the fabric by applying the adjusted physical property parameters to the machine learning model, and configure the mesh of fabric to extend to the determined contour of fabric.

In one or more embodiments, the instructions to generate the mesh of the fabric further cause the processor to generate a first portion of the mesh on an upper surface of the object, generate a second portion of the mesh extending from the first portion of the mesh by a predetermined width, and generate a third portion of the mesh extending from the second portion of the mesh to the contour.

In one or more embodiments, the instructions cause the processor to store correlation between the physical property parameters, wherein the adjustment to the at least the subset of the physical property parameters is constrained by the stored correlation.

In one or more embodiments, the instructions cause the processor to display a visual effect indicating violation of constraints on the physical property parameters as indicated by the stored correlation on the user interface elements responsive to the adjustment violating the constraints.

In one or more embodiments, the instructions cause the processor to receive fabric information from the user via the user interface elements; and determine the physical property parameters corresponding to the received fabric information by applying the fabric information to a generative model for generating the physical property parameters.

Embodiments also relate to a non-transitory computer-readable storage medium storing a machine learning model where the machine learning model is generated by performing simulation of draping of fabrics with corresponding physical property parameters using a non-machine learning model to generate simulation results representing contours of the draped fabrics, providing the physical property parameters and the simulation results to the machine learning model as training data; and updating the machine learning model according to differences between predicted contours of the draped fabrics generated by the machine learning model and the simulation results.

In one or more embodiments, the machine learning model is generated further by randomly sampling the physical property parameters for training.

In one or more embodiments, the sampling is performed according to a probability distribution of verified physical property parameters.

### BRIEF DESCRIPTION OF DRAWINGS

The teachings of the embodiments of the present invention can be readily understood by considering the following detailed description in conjunction with the accompanying drawings.

FIG. 1 is a flowchart illustrating a method of performing 3-dimensional (3D) fabric draping simulation, according to an embodiment.

FIG. 2 is a diagram illustrating a process of generating a draping simulation result of 3D fabric based on predicted contour of a draped fabric, according to an embodiment.

FIG. 3A is a diagram illustrating a graphical user interface for adjusting physical property parameters, according to an embodiment.

FIG. 3B is a diagram illustrating a graphical user interface where a constraint is set on physical property parameters, according to an embodiment.

FIG. 4 is a diagram illustrating a process of sequentially draping 3D fabric on an object, according to an embodiment.

FIG. 5 is a block diagram illustrating a simulation device according to various embodiments.

FIG. 6 is a diagram illustrating an example of a left shear force parameter and a right shear force parameter varying depending on a fabric type, according to an embodiment.

FIG. 7 is a diagram illustrating a graph-based user input interface, according to an embodiment.

### DETAILED DESCRIPTION

The following structural or functional descriptions are exemplary to merely describe the embodiments, and the scope of the embodiments is not limited to the descriptions provided in the present specification.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It should be noted that if one component is “connected,” “coupled”, or “joined” to another component, a third component may be “connected,” “coupled”, and “joined” between the first and second components, although the first component may be directly connected, coupled, or joined to the second component. On the contrary, it should be noted that if it is described that one component is “directly connected,” “directly coupled”, or “directly joined” to another component, a third component may be absent. Expressions describing a relationship between components, for example, “between,” directly between,” or “directly neighboring”, etc., should be interpreted alike.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more of other features, integers, steps, operations, elements, components, and/or groups thereof. Unless otherwise defined, all terms, including technical and scientific terms, used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. In the drawings, like reference numerals are used for like elements.

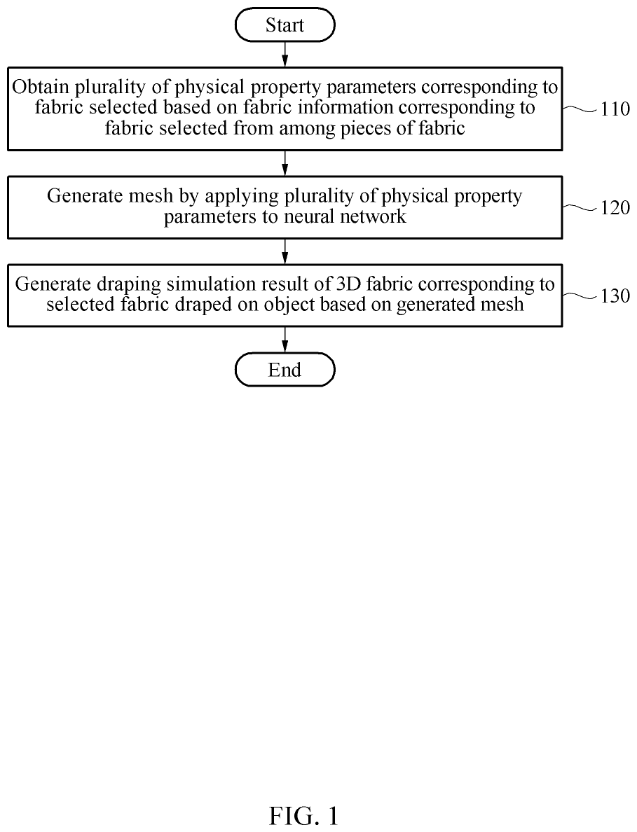

FIG. 1 is a flowchart illustrating a method of a 3-dimensional (3D) fabric draping simulation, according to an embodiment. First, the physical property of fabric may be measured to obtain initial values of physical property parameters of a fabric. For this purpose, most 3D garment simulation software may include a measuring device for their own simulators. However, the accuracy of the initial values of the physical property parameters obtained by the measuring device may not be sufficient for use in developing an actual product. For example, a draping simulation result of 3D fabric assigned with the initial values of the physical property parameters may not be sufficiently similar to a draping result of an actual fabric. Therefore, as a next operation, tuning of the physical property parameter may be performed. The tuning of the physical property parameter may involve a repeated process of adjusting the physical property parameters. For example, the process of adjusting the physical property parameters includes a recursive process of adjusting at least a subset of the physical property parameters according to a user's intuition, and then simulating (e.g., physics-based simulation) and verifying a draping result of the 3D fabric corresponding to the adjusted physical property parameter. However, such simulation (e.g., physics-based simulation) may consume at least tens of seconds in a computing device. Accordingly, a prolonged time may be spent to complete the tuning of the physical property parameters for a certain piece of fabric. Therefore, it is describable to decrease the time for performing the draping simulation of the 3D fabric during a tuning process of the physical property parameters.

The draping described herein refers to a process of placing fabric on an object. The object onto which the object is draped may be a 3D avatar. Various draping methods may be used to analyze the features of a fabric. Cusick draping method is one of various draping methods used in the textile industry. The Cusick draping method may start with an operation of placing a 30 cm sample on the upper surface of a cylindrical cylinder of which a diameter is 18 cm. A portion of fabric that is not supported by the cylindrical cylinder may sag down and form a draping shape of the fabric. Another draping method may place a 30 cm×30 cm square fabric sample on a cylindrical cylinder of which a diameter is 10 cm.

The physical property parameters may include parameters converted from values measured by the measuring device using an algorithm. For example, a user may measure a bending angle of a fabric sample in a certain position. A simulation device may calculate a bending force parameter, that is, a physical property parameter, based on the measured bending angle.

In addition, the physical property parameter may be estimated through machine learning. A machine learning approach may include an optimization method and a supervised learning method. The optimization method may be a method of finding an optimal value while adjusting the physical property parameter until a draping simulation result with a discrepancy to a target draping result below a threshold. The supervised learning method may involve training a machine learning model to learn a correlation between physical property parameters and draping shapes.

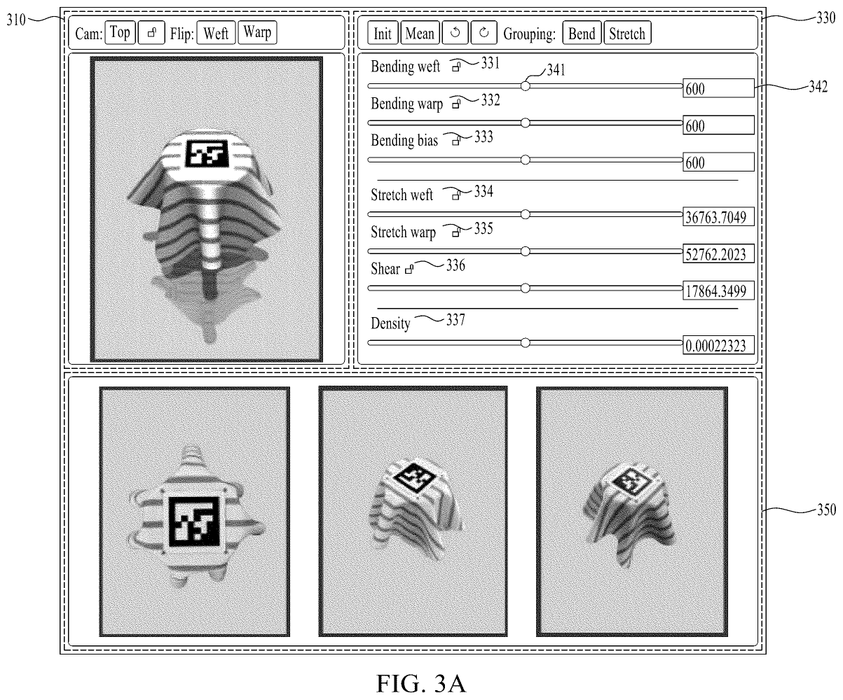

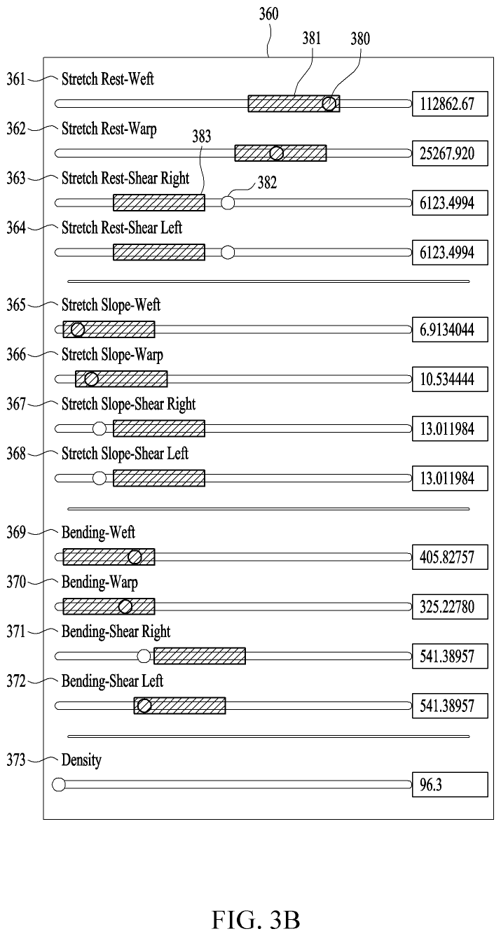

A simulation device 500 may display initial values of physical property parameters of a fabric selected by the user on a user interface. For example, referring to FIG. 3B, the simulation device 500 may display an initial value of a physical property parameter through a pointer on a slide bar.

According to an embodiment, in operation 110, the simulation device 500 may obtain a plurality of physical property parameters corresponding to the fabric selected based on fabric information corresponding to the fabric. The simulation device 500 may determine the selected fabric based on a user input. For example, the simulation device 500 may determine that the selected fabric to be cotton (among, e.g., natural fiber fabric, synthetic fiber, fabric, cotton, linen, wool, polyester, and nylon) based on a user's input indicating the cotton. When the selected fabric is ‘cotton’, the simulation device 500 may display on the user interface respective initial values of physical property parameters corresponding to the ‘cotton.’

According to an embodiment, the simulation device 500 may obtain a plurality of physical property parameters by applying fabric information to a physical property parameter generation model. For example, when the selected fabric is ‘cotton,’ the simulation device 500 applies fabric information corresponding to the ‘cotton’ to the physical property parameter generation model and obtain respective values of the physical property parameters corresponding to the ‘cotton.’ The physical property parameter generation model may be a model using fabric information as input data and a plurality of physical property parameters as output data. The physical property parameter generation model may be a model trained to learn a correlation between fabric information and physical property parameters corresponding to the fabric information. For example, the physical property parameter generation model may include at least one of a regression model (e.g., Bayesian ridge regression, generalized linear regression, and polynomial regression) or a neural network model (e.g., a neural network including a fully connected layer).

According to an embodiment, fabric information corresponds to a selected fabric. The fabric information may include at least one of a fabric type, composition information, and unit weight information.

Example types of the selected fabric may include, among others, ‘boucle’, ‘canvas’, ‘challis’, ‘chambray/oxford’, ‘chiffon’, ‘clip jacquard’, ‘corduroy’, ‘crepe/crepe de chine (CDC)’, ‘crepe knit’, ‘crochet’, ‘denim’, ‘Dewspo’, ‘dobby’, ‘dobby mesh’, ‘double knit/interlock’, ‘double weave’, ‘eyelet’, ‘flannel’, ‘flatback rib’, ‘fleece’, ‘French terry’, ‘gauze/double gauze’, ‘georgette’, ‘interlock twist yarn (ITY)/matte jersey’, ‘jacquard/brocade’, ‘jacquard knit’, ‘jersey’, ‘lace’, ‘loop terry’, ‘low gauge knit’, ‘Melton/boiled’, ‘memory’, ‘mesh/tulle’, ‘neoprene/scuba’, ‘organza’, ‘ottoman’, ‘polyvinyl chloride (PVC)’, ‘pique’, ‘plaid’, ‘plain’, ‘Pointelle’, ‘polar fleece’, ‘Ponte’, ‘poplin’, ‘quilted knit’, ‘rib’, ‘ripstop’, ‘satin’, ‘seersucker’, ‘sherpa’, ‘polyester/rayon/spandex (TRS)’, ‘taffeta’, ‘tricot’, ‘tweed’, ‘twill’, ‘Tyvek’, ‘vegan fur’, ‘vegan leather’, ‘vegan suede’, ‘velour’, ‘velvet’, ‘velvet/velveteen’, ‘voile’, and ‘waffle’.

The type of the selected fabric may be expressed as a vector (e.g., one hot vector) of Nth dimension. For example, when a first component of a vector indicates ‘boucle’, a vector corresponding to the ‘boucle’ may be expressed as (1, 0, 0, 0, 0, . . . , 0), and when a second component of a vector indicates ‘canvas’, a vector corresponding to the ‘canvas’ may be expressed as (0, 1, 0, 0, . . . , 0).

The composition information may be blend ratio information of constituents of fabric. A fabric may include, for example, combinations of ‘acetate’, ‘acrylic’, ‘alpaca’, ‘aluminum’, ‘angora’, ‘bamboo viscose’, ‘cationic dyeable polyester (CDP)’, ‘camel’, ‘cashmere’, ‘cation’, ‘cork’, ‘cotton’, ‘Cupro’, ‘ethylene-vinyl acetate copolymer (EVA)’, ‘jute’, ‘linen’, ‘lyocell’, ‘metallic’, ‘modal’, ‘mohair’, ‘nylon’, ‘organic cotton’, ‘polyethylene (PE)’, ‘polyethylene terephthalate (PTT)’, ‘polyvinyl chloride (PVC)’, ‘pima cotton’, ‘polyester’, ‘ramie’, ‘recycled nylon’, ‘recycled polyester’, ‘silicone’, ‘silk’, ‘spandex/elastane’, ‘supima cotton’, ‘triacetate (TA)’, ‘Tencel™’, ‘lyocell’, ‘Tencel™ modal’, ‘thermoplastic poly urethane (TPU)’, ‘triacetate’, ‘viscose rayon’, ‘viscose from bamboo’, and ‘wool’. When a fabric is blended with two constituents, such as cotton/PE, the composition information may include a blend ratio (e.g., 6:4) of the constituent materials.

The unit weight information may be a weight per unit area of fabric.

According to an embodiment, in operation 120, the simulation device 500 may generate a mesh by applying a plurality of physical property parameters to a neural network. The neural network may include a neural network learning a correlation between the physical property parameters and the mesh in which the 3D fabric is draped on the object. For example, the neural network may include at least one of a graph neural network (GNN), a counterfactual multi-agent (CoMA), and a SpiralNet.

According to an embodiment, the physical property parameters applied to the neural network may include a value adjusted based on a user input. Prior to the operation of generating the mesh, the simulation device 500 may adjust the physical property parameters as indicated by the user. For example, the physical property parameters obtained in operation 110 may be displayed on the slide bar as a pointer after respective initial values thereof are set as illustrated in FIG. 3B. The user may adjust each of the physical property parameters by moving the pointer on the slide bar displayed on a screen 360 of FIG. 3B. The simulation device 500 may adjust each of the physical property parameters through the slide bar based on the user input. The simulation device 500 may generate the mesh by applying the adjusted physical property parameters (or respective values of the physical property parameters) to the neural network.

The simulation device 500 may encode the physical property parameters into a latent vector. The simulation device 500 may generate the mesh by applying the encoded latent vector to the neural network. The simulation device 500 may obtain a realistic draping simulation result by using the latent vector as input data of the neural network for mesh generation.

The physical property parameters described herein refers to parameters representing the physical properties of a fabric. The physical property parameters may include, among others, a stretch force parameter, a bending force parameter, and a density parameter. Stretch may represent a repulsive force against stretching in a direction (e.g., horizontal, vertical, or diagonal direction). The stretch may be the property of stretching and contracting of a fabric. A bending force may be a repulsive force against bending of a fabric. Density may be obtained by dividing the mass of a fabric by the total area of the fabric.

The stretch force parameter may include at least one of a weft stretch force parameter, a warp stretch force parameter, and a shear force parameter. A shear force may be a force acting parallel to a surface or a planar cross section of an object. The weft stretch force parameter may include at least one of a weft stretch rest parameter and a weft stretch slope parameter. The warp stretch force parameter may include at least one of a warp stretch rest parameter and a warp stretch slope parameter. The shear force parameter may include at least one or both of a right shear force parameter and a left shear force parameter. The right shear force parameter may include at least one of a stretch rest of a right shear force and a stretch slope of a right shear force. The left shear force parameter may include at least one of a stretch rest of a left shear force and a stretch slope of a left shear force.

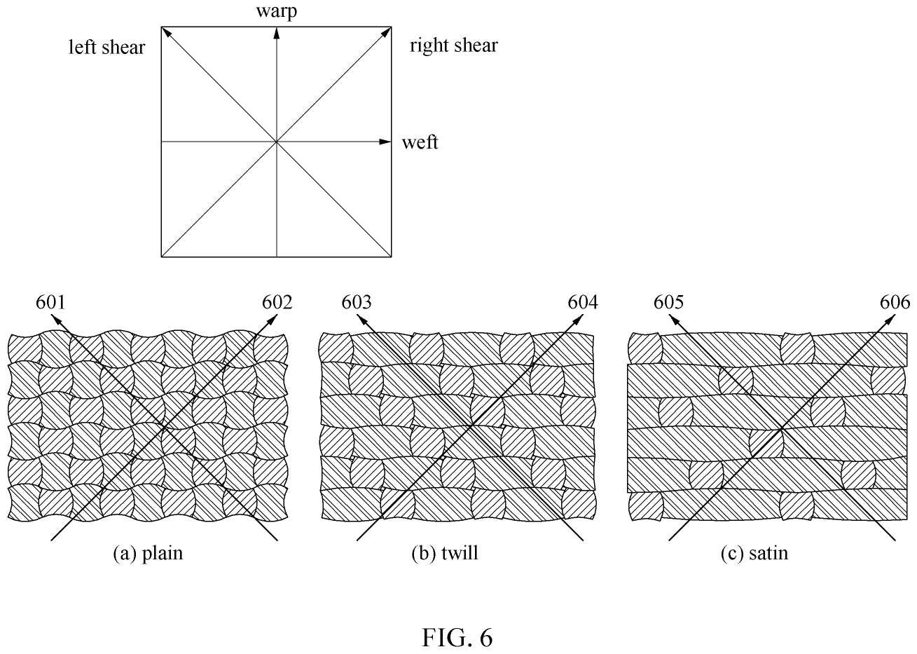

Referring to FIG. 6, when the fabric type is plain, a left bias 601 and a right bias 602 are the same. Therefore, when any one value of a left shear force parameter and a right shear force parameter is obtained, the same value may be applied to the other. However, when the fabric type is twill or satin, left biases 603 and 605 are respectively different from right biases 604 and 606. Therefore, the left shear force parameter and the right shear force parameter may each be obtained to express the property of actual fabric. In other words, embodiments may use two shear parameters, not using only one shear parameter.

The bending force parameter may include at least one of a weft bending force parameter, a warp bending force parameter, a right shear bending force parameter, a left shear bending force parameter, and a diagonal bending force parameter. The weft may be a thread of a horizontal direction of fabric, which may be also referred to as a ‘weft thread.’ In addition, the warp may be a thread of a vertical direction of the fabric, which may also be referred to as a ‘warp thread.’

The fabric also includes knit or felt. For example, the fabric may include at least one of natural fiber fabric, synthetic fiber fabric, or blended yarn fabric, such as cotton, linen, wool, polyester, nylon, and elastane, dobby/jacquard, jersey, dobby, jacquard/brocade, plain, double knit/interlock, clip jacquard, mesh/tulle, twill, lace, rib, crepe/CDC, corduroy, challis, chiffon, vegan leather, flannel, denim, velvet, tweed, satin, Dewspo, PVC, raschel, double weave, eyelet, fleece, gauze/double gauze, vegan fur, chambray/oxford, sequin, tricot, French terry, organza, vegan suede, Ponte, polar fleece, neoprene/scuba, ripstop, seersucker, boucle, poplin, voile, canvas, velour, georgette, pique, TRS, taffeta, Melton/boiled, loop terry, crepe jersey, waffle, sherpa, pointelle, memory, plaid, and Tyvek.

The physical property parameters may include parameters received through a first area of a screen where user interface elements for receiving input associated with the physical property parameters from a user. Referring to FIG. 3A, physical property parameters may be displayed in first area 330. In addition, user interface elements for receiving a user input of the physical property parameters may be displayed in the first area 330. The first area 330 may include user interface elements associated with at least one of a weft bending force parameter 331, a warp bending force parameter 332, a diagonal bending force parameter 333 (for example, a diagonal bending force parameter may be also referred to as a bending bias), a weft stretch force parameter 334, a warp stretch force parameter 335, a shear force parameter 336, and density 337. In the example of FIG. 3A, the user may input a physical property parameter value through the first area 330 by sliding knob 341. A physical property parameter value adjusted by the knob 341 may be displayed in box 342 with the exact value corresponding to the location of the knob 341.

A correlation between physical property parameters and a contour of 3D fabric draped on an object may be a log-linear relationship. Accordingly, the input element of the physical property parameters displayed in the first area 330 of FIG. 3A may be logarithmic.

According to an embodiment, the simulation device 500 may set a constraint on physical property parameters, based on correlation between the physical property parameters. The physical property parameters of an actual fabric may be correlated. For example, when a weft stretch force is 10, a warp stretch force may be in a range of 8 to 12. As another example, when the weft stretch force is 10, a weft bending force may be in a range of 3 to 5. Such correlation stored in the simulation device 500. The correlation of the physical property parameters may be stored, for example, in the form of one or more lookup tables (LUTs). By setting a constraint on physical property parameters based on the correlation between the physical property parameters, the user may obtain a draping simulation result of 3D fabric that is more realistic without prior knowledge of the correlation between the physical property parameters.

According to an embodiment, the correlation may be information determined based on possible distribution of physical property parameters of a fabric. For example, the possible distribution of the physical property parameters varies depending on whether the fabric is a natural fiber fabric or a synthetic fiber fabric. Accordingly, the simulation device 500 may generate the correlation between the physical property parameters of a type of fabric based on the possible distribution of the physical property parameters of that type of fabric.

According to an embodiment, the correlation information may include information converting a correlation between M physical property parameters (i.e., M dimensions) into a correlation between N parameters (i.e., N dimensions) (where M is an integer granter than N which is also an integer). For example, when there are 8 physical property parameters, the property of fabric may be expressed in 8 dimensions. The simulation device 500 may decrease the physical property parameters in 8 dimensions to 2 dimensions by using a dimension reduction method. For example, the simulation device 500 may convert a correlation between 8 physical property parameters into a correlation between 2 physical property parameters. Such reduction in the dimension may be performed by the simulation device 500 using, for example, a linear dimension reduction method, a nonlinear dimension reduction method, and a deep learning method. The linear dimension reduction method may include principal component analysis (PCA) and linear discriminant analysis (LDA). The nonlinear dimension reduction method may be, for example, kernel PCA or t-distributed stochastic neighbor embedding (t-SNE). The deep learning method may include at least one of auto-encoders and variational auto-encoders (VAEs).

According to an embodiment, fabric information (e.g., a fabric type, a fabric combination, and a fabric weight) may be received from the user. In response, a plurality of physical property parameters matching the received fabric information may be obtained. The physical property parameters matching with the fabric information may be obtained from a database in the form of a lookup table form or may be obtained by performing further processing (e.g., interpolation) on the information stored in the database. Alternatively, the physical property parameters matching the fabric information may be inferred by a pretrained neural network.

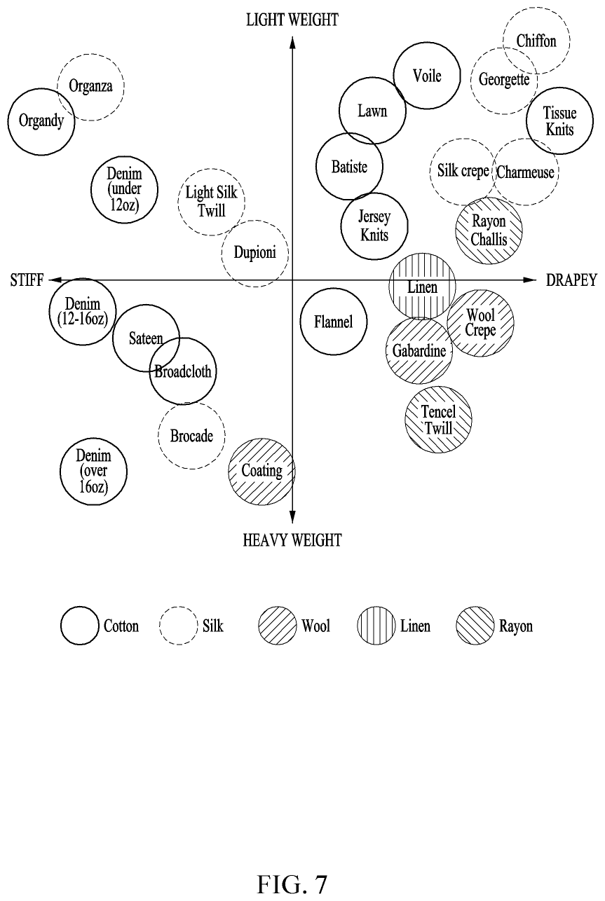

Referring to FIG. 7, fabric information may be received from the user through a graph of a predetermined dimension. The graph illustrated in FIG. 7 is a 2D graph in which a first axis (e.g., an x-axis) indicates the stiffness of fabrics and a second axis (e.g., a y-axis) indicates the weight associated with the fabrics. Various types of fabrics may be represented on the graph. The user may select fabric of desired features through the graph.

In addition, the various types of fabrics may be expressed as zones on the graph where each zone has a respective range along an axis. For example, each of the fabric types on the graph may be expressed as a zone including a range of combining features (e.g., stiffness and a weight) represented by the axes. When features represented by the axes are within the range of a certain type of fabric, a zone may be classified as that certain type of fabric. After identifying the type of fabric as indicated by the zone in a graphical user interface, the user may specify a more detailed range corresponding to the fabric of choice. For example, when the user intends to extract slightly ‘less’ stiff denim, the user may select a position closer toward drapey within the range of denim. Through the user interface described with reference to FIG. 7, a user may select a fabric type and adjust detailed fabric information within a limited range of the selected fabric type at the same time.

The zones on the graph may be respectively related to constraints of physical property parameters of fabric types corresponding to the zones. According to an embodiment, a user may be allowed to select physical property parameters within the zones. Alternatively, when the user provides a selection outside the zones, the violation of a constraint may be visually displayed through warning text or change in color of user interface elements (e.g., the graph or a slide bar) and/or a rendering result.

According to an embodiment, a close-up image including the texture of fabric may be received from the user. In this case, the fabric information may be obtained from the texture of the fabric. For example, the fabric type may be estimated based on the weaving of the texture included by the image. The physical property parameters matching the fabric information may then be obtained.

In one or more embodiments, a neural network learning correlation between the physical property parameters and the mesh of a 3D fabric draped on the object may be used. The neural network may include a fully connected layer. The neural network may use, for example, an activation function (e.g., a rectified linear unit (ReLU)) for each layer except for its output layer.

The object may be used for a draping simulation of fabric, and may be a 3D cylindrical cylinder, for example. In another example, the object may be a 3D avatar. When the object is the 3D avatar, the simulation device 500 may generate a simulation result of draping a garment made of the fabric on the 3D avatar. To generate the simulation result of draping the garment on the 3D avatar, the simulation device 500 may use a mesh-net.

For the purpose of obtaining the training data for the neural network, the simulation device 500 may randomly sample physical property parameters. The simulation device 500 may then execute simulation of draping a fabric with the sampled physical property parameters. The simulation device 500 may exclude, from sampling, physical property parameters that may be physically impossible or that may not be related to fabric. Such invalid physical parameters may cause a divergence problem in simulation and unnecessarily expand a spatial area of physical property parameters, and impede the training of the neural network. To avoid such a risk, physical property parameters may be sampled according to a probability distribution of verified physical property parameter sets. The simulation device 500 may store verified physical property parameter sets for different types of fabric. For example, a Gaussian mixture model (GMM) including 5 components may be suitable for 400 physical property parameters. The simulation device 500 may perform a large amount of physical property parameter sampling according to a probability distribution of the GMM.

Physical property parameters provided to the neural network may be normalized by logarithmic transformation. For example, each of the physical property parameters may be adjusted to a range of [0, 1]. The reason for normalizing by logarithmic transformation is that prior researches indicate that a change in a physical property parameter and a change in a draping shape are in a log linear relationship.

According to an embodiment, the simulation device 500 may train the neural network by defining a mesh of 3D fabric itself as output data. However, when using mesh data of the 3D fabric as the training data, the neural network may become excessively complex and yield less accurate results.

According to an embodiment, the simulation device 500 may define a contour (e.g., an edge curve) of the draped 3D fabric as the output data of the trained neural network. From the contour of the draped 3D fabric, the draping simulation result of the 3D fabric may be estimated. For example, when there are 244 uniformly sampled 3D points of the contour, the 3D points may be expressed as a sequence in a vector representing the contour. Because 3D point on the contour has x, y, z coordinates (3 coordinate values), the vector is of 732 (=3×244) dimension.

According to an embodiment, the simulation device 500 may sample a plurality of physical property parameter sets (e.g., 100,000 sets) by using the GMM. Then, the simulation device 500 may execute a draping simulation of the 3D fabric by using each of the sampled physical property parameter sets. The draping simulation for generating the training data may be performed using a non-machine learning method (e.g., physics-based simulation). In addition, when a simulation result does not converge to a shape after a certain time, or when a final draping shape is determined to be not of an expected fabric form (e.g., too droopy or falling off to the ground), the simulation device 500 may remove such simulation results from the training data. The simulation device 500 may use 80% of data obtained in the above method for the training of the neural network and divide the remaining 20% of the data into halves and respectively use the divided pieces of data as test data and verification data. The simulation device 500 may train the neural network for 300 epochs by using, for example, a mean square error loss function and an Adam optimizer, but examples are not limited thereto. The simulation device 500 may calculate, for example, an error Eₘ(y, y̅ₗ) of each prediction in millimeters to intuitively understand the prediction error of the neural network, as shown in the following equation:

$${E}_{m} ( y , \overline{{y}_{i}} ) = \frac{1}{n} {\sum }_{i = 1}^{n} ‖ y , - \overline{{y}_{i}} ‖$$

where yᵢ and y̅ₗ respectively denote a coordinate of an i^{th} sampled point on an actual contour and a coordinate of a corresponding i^{th} sampled points on a contour predicted by the neural networks.

Contour information may include 3D coordinates corresponding to a contour of 3D fabric draped on an object. The 3D coordinates corresponding to the contour may include coordinates of 3D points corresponding to a contour of fabric on an object (e.g., a 3D geometric object, such as a cylindrical cylinder). In one embodiment, the simulation device 500 may sample 3D points corresponding to the contour of the 3D fabric from a 3D scanned image or a depth image including a 3D contour of the fabric on the object and generate the contour information through a process of obtaining the coordinates of the sampled 3D points instead of performing physics-based simulation on a virtual fabric.

At least some area of the fabric may be placed on the object and supported by the object, and the rest of the area may not be supported by the object and sag toward the floor under the influence of gravity. Accordingly, the contour of the 3D fabric draped on the object may be formed by an outer line of the rest of the area of the fabric not supported by the object.

According to an embodiment, the simulation device 500 may generate a draping simulation result of the 3D fabric draped on the object based on the generated mesh in operation 130.

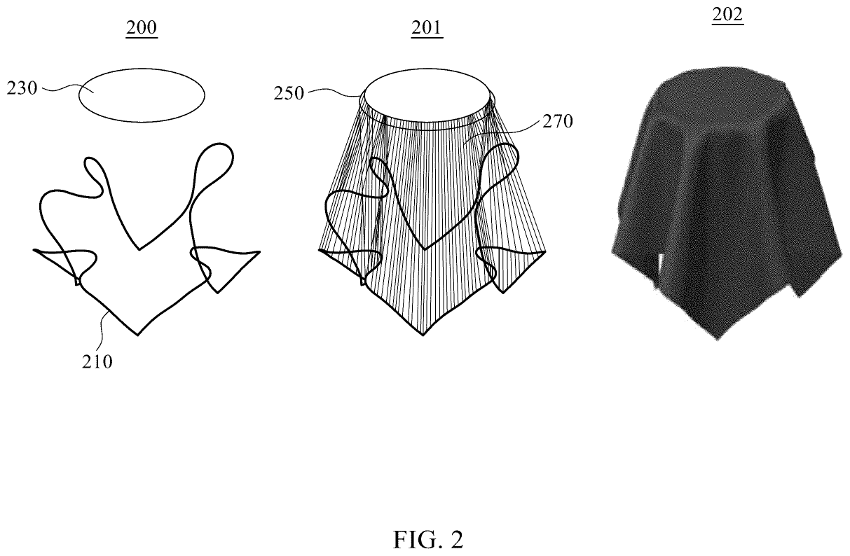

According to another embodiment, the draping simulation result of the 3D fabric is described in detail with reference to FIG. 2. FIG. 2 illustrate a process of generating a simulation result. According to an embodiment, the simulation device 500 may generate contour information by applying physical property parameters to a trained neural network. In addition, the simulation device 500 may generate contour 210 of 3D fabric draped on an object based on the contour information. According to an embodiment, the simulation device 500 may generate a first portion 230 of mesh of fabric on an upper surface of the object. The first portion 230 of the mesh may be, for example, a circular mesh. The simulation device 500 may set the position of the first portion 230 to be higher than the upper surface of the object to account for the thickness of the fabric. According to an embodiment, the simulation device 500 may generate a second portion 250 of the mesh along an outer line of the upper surface. When the object is a cylindrical cylinder as illustrated in FIG. 2, the second portion 250 of the mesh may be, for example, a ring-shaped triangular strip mesh. In this case, the width of the second portion 250 of the mesh may to a predetermined value (e.g., 4 mm). Accordingly, when the object is in the shape of a cylindrical cylinder, the upper surface of the object may be circular, and the outer line may be circular (hereinafter, a first circle). In addition, after generating another circle (hereinafter, a second circle) in a position apart from the circular outer line by the predetermined value (e.g., 4 mm), the simulation device 500 may generate the second portion 250 of the mesh between the first circle and the second circle. In this case, the position of the second circle may be, for example, lower than the first circle by the predetermined value (e.g., 4 mm). The simulation device 500 may use the second portion 250 of the mesh to smooth out the draping around the outer line of the upper surface of the object. According to an embodiment, the simulation device 500 may generate a third portion 270 of the mesh between the contour 210 and the second portion 250 of the mesh. When the object is of a cylindrical shape, the simulation device 500 may generate, for example, the third portion 270 of the mesh between the contour 210 and the second circle. As a result, the simulation device 500 may generate a simulation result 202 of draping the 3D fabric on the object.

According to an embodiment, the simulation device 500 may output a draping simulation result of the 3D fabric through a second area of the screen where the simulation result is displayed. When the simulation device 500 is a server that is remote from a user terminal, the simulation device 500 may send the draping simulation result of the 3D fabric to the user terminal so that the draping simulation result is displayed in the second area of a screen of the user terminal. When the simulation device 500 itself is the user terminal, the simulation device 500 may render and display the draping simulation result of the 3D fabric through the second area of a screen of the simulation device 500. FIG. 3A illustrates the draping simulation result of the 3D fabric being displayed in second area 310 that is located adjacent to first area 330. A user may readily tune physical property parameters by viewing the result of the simulation in the second area 310 and adjusting the physical property parameters in the first area 330. The simulation device 500 may output the draping simulation result of the 3D fabric through the second area 310 in real time as the user adjusts a physical property parameter in the first area 330.

In an embodiment, the draping simulation result of the 3D fabric may include mesh data related to the physical property of the 3D fabric, normal map data related to the texture of the 3D fabric, graphic data related to the visual property of the 3D fabric or a combination thereof. For example, a virtual fabric may include a mesh (physical property), a normal map (texture) and graphics (visual properties, such as color, transparency, and reflection).

According to an embodiment, the draping simulation result of the 3D fabric may further include at least one of thickness data of the 3D fabric and texture data of the 3D fabric in a form combinable with the mesh data. According to an embodiment, thickness information included by fabric information may be used for rendering. The thickness (e.g., an average thickness) statistically processed according to fabric may be automatically reflected, and the user may input or change the thickness. In addition, the texture (normal+graphic) may be automatically applied according to the type of the fabric and may be changed by the user.

According to an embodiment, the simulation device 500 may display image data of physics-based simulation or reference images of actual fabrics in third area 350 of the user interface. The image data in third area 350 may be data that may be referenced by the user during the tuning of physical property parameters. Referring to FIG. 3A, the simulation device 500 may display the image data through the third area 350. The user may refer to the image data in third area 350 and determine whether the draping simulation result of the 3D fabric in second area 310 are similar to images shown in third area 350. When there is a difference between the simulation result and the actual draping result of the 3D fabric, the user may adjust the physical property parameters by manipulating user interface elements in the first area 330 and obtain an image of simulation based on a trained neural network in second area 310 and compare it with the images in third area 350. In third area 350, images capturing physics-bases simulation or an actual draping results from different viewpoints may be displayed.

According to an aspect, by using a neural network trained with correlation between physical property parameters and a contour of a draped 3D fabric, changes in the shape of the draped 3D fabric may be displayed and verified in real-time as changes are made to physical property parameters of the fabric. By providing user interface elements for tuning physical property parameters of a fabric, a user may also readily adjust the physical property parameters.

Embodiments may be implemented as distributable software or web services. When implemented as web services, a server may drive a machine learning (ML) model, and a result may be displayed through a web viewer by receiving a user input online.

The layout of the screen in FIG. 3A is merely an example. Other areas may be provided in the screen to provide information besides the first area 330, the second area 310, and the third area 350. In addition, some of the first area 330, the second area 310, and the third area 350 may be omitted or may be arranged in a different configuration.

Two or more draping simulation results of target fabric that are generated in different draping methods may be used to increase the tuning accuracy of physical property parameters. Therefore, the simulation device 500 may simultaneously output different draping simulation results on a screen. Since the user may view draping results generated respectively in a plurality of draping methods on a single screen, the tuning accuracy of physical property parameters may also be increased. The simulation device 500 may output the draping simulation results generated in the different draping methods, for example, through the second area 310 where draping simulation results are displayed.

FIG. 3B is a diagram illustrating a screen where a constraint is placed on a user input of physical property parameters. Screen 360 of FIG. 3B illustrates a plurality of physical property parameters 361 through 373. The simulation device 500 may receive an input of a physical property parameter value from the user through a user interface element (e.g., a slide bar 380) on the screen 360. As illustrated on the screen 360 of FIG. 3B, different user interface elements are used for adjusting property parameters 361 through 373.

The permissible input through the user interface elements may be constrained. For example, a permissible input range 381 of the physical property parameter 361 may be displayed in the trop user interface element. The user may adjust physical property parameter value by moving a slide bar 380 along a slide bar. The simulation device 500 may limit a user input to receive a physical property parameter value in a range allowed under the constraints. For example, the simulation device 500 may set such that the slide bar 380 of the slide bar may be adjusted only within the permissible input range 381.

As another example, the simulation device 500 may allow a user to provide an input that violates constraints on a physical property parameter value. For example, the simulation device 500 may allow the knob 382 of the slide bar to be moved beyond the permissible input range 383. In this case, however, the simulation device 500 may notify the user of constraint violation through a visual effect.

According to an embodiment, the simulation device 500 may display the permissible input range 381 on a slide bar 380 for inputting a physical property parameter based on the constraints. The user may select a physical property parameter value in a range of the permissible input range 381. The simulation device 500 may determine a constraint based on a correlation between physical property parameters as stored in the simulation device 500.

A physical property parameter value adjusted through a user input may violate constraints, for example, by having a physical property parameter value that is beyond the permissible input range. For example, the constraints may be violated when a value of the physical property parameter 361 is beyond the permissible input range 381. When the constraint is violated, the simulation device 500 may display a visual effect indicating constraint violation on a slide bar corresponding to the physical property parameter. For example, the simulation device 500 may display the visual effect by changing at least one of the color, transparency, or brightness of the permissible input range 381. For example, when a constraint is violated, the color of the permissible input range 381 may be changed from blue to red. For example, when a constraint is violated, the simulation device 500 may get the permissible input range 381 to flicker. As another example, the simulation device 500 may display a constraint violation message on a screen when a physical property parameter value adjusted through the user input violates the constraint. Also, the violation of the constraint may be indicated by a visual effect at a knob of a slide bar. For example, the knob 382 of the slide bar for setting a physical property parameter value being outside a permissible input range 383 may apply to constraint violation. When a constraint is violated, the simulation device 500 may change at least one of the color, transparency, or brightness of the knob 382 of the slide bar. For example, the simulation device 500 may change the color of a pointer from blue to red.

When a value of a physical property parameter adjusted through the user input violates a constraint, the simulation device 500 may adjust the value of the physical property parameter to a value, allowed under the constraint, of the physical property parameter. For example, the knob 382 of the slide bar may be outside the permissible input range 383. The simulation device 500 may adjust the value of the physical property parameter such that the knob 382 of the slide bar outside the permissible input range 383 may be pulled into the permissible input range 383. The simulation device 500 may adjust a physical property parameter value to a physical property parameter value (e.g., an initial value) generated through a physical property parameter generation model. As another example, the simulation device 500 may adjust the physical property parameter value to an intermediate value of a permissible input range.

According to an embodiment, when a physical property parameter value adjusted through the user input violates a constraint, the simulation device 500 may provide information related to constraint violation through an area other than the slide bar. For example, when rendering the draped 3D fabric shape (e.g., a second area), the simulation device 500 may display constraint violation by changing the color of fabric (e.g., to red).

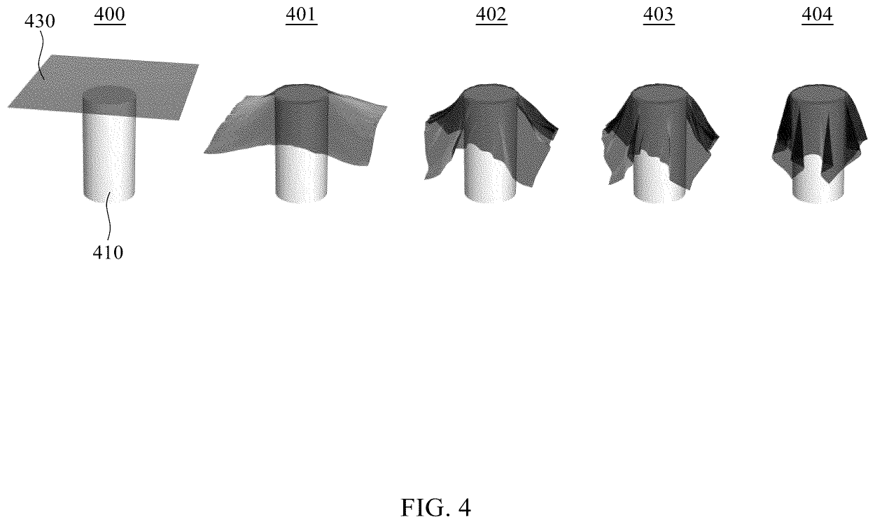

FIG. 4 illustrates a cylindrical cylinder 410, fabric 430, an initial state 400, intermediate states 401, 402, and 403, and a final state 404, according to one embodiment. From the initial state 400 to the final state 404, portions of fabric not touching the upper surface of the cylindrical cylinder 410 may be gradually slid down by gravity. A termination condition for determining the final state 404 may be a case where a processing speed for a vertex is less than or equal to a certain threshold value. A simulation time may be set to 0.033 minutes for all experiments, but examples are not limited thereto. The time taken to satisfy the termination condition may vary depending on physical property parameters. Some physical property parameters may likely delay the time taken to satisfy the termination condition.

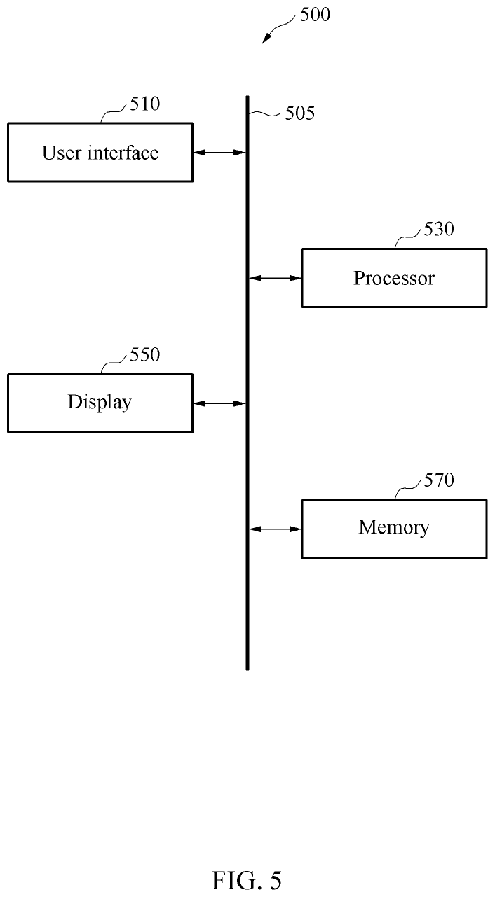

FIG. 5 is a block diagram illustrating a simulation device according to various embodiments. According to an embodiment, the simulation device 500 may be a server. According to another embodiment, the simulation device 500 may be a user terminal (e.g., a mobile device, a desktop computer, a laptop computer, a personal computer, etc.). Referring to FIG. 5, according to an embodiment, the simulation device 500 may include a user interface 510, a processor 530, a display 550, and a memory 570. The user interface 510, the processor 530, the display 550, and the memory 570 may be connected to one another through a communication bus 505.

The user interface 510 may receive a user input for each of a plurality of physical property parameters. The user interface 510 may receive the user input for each of the physical property parameters through, for example, a keyboard, a stylus pen, a mouse click, and/or a touch input through a user's finger.

The display 550 may display a simulation result of 3D fabric generated by the processor 530. The simulation device 500 may output at least one of the first area 330, the second area 310, and the third area 350 on the display 550.

The memory 570 may store the generated simulation result of 3D fabric. In addition, the memory 570 may store various pieces of information generated in the process of the processor 530 described above. In addition, the memory 570 may store various pieces of data, programs, and the like. The memory 570 may include a volatile memory or a non-volatile memory. The memory 570 may include a massive storage medium, such as a hard disk, and store the various pieces of data.

In addition, the processor 530 may perform one or more methods described with reference to FIGS. 1 through 3B or an algorithm corresponding to the one or more methods. The processor 530 may be a hardware-implemented data processing device including a circuit that is physically structured to execute desired operations. For example, the desired operations may include code or instructions in a program. The processor 530 may be implemented as, for example, a central processing unit (CPU), a graphics processing unit (GPU), or a neural network processing unit (NPU). For example, the simulation device 500 that is implemented as hardware may include, for example, a microprocessor, a CPU, a processor core, a multi-core processor, a multiprocessor, an application-specific integrated circuit (ASIC), and a field-programmable gate array (FPGA).

The processor 530 may execute a program and control the simulation device 500. The code of the program executed by the processor 530 may be stored in the memory 570.

The methods according to the above-described examples may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

Various modifications may be made to embodiments described above. Suitable results may be achieved if the described techniques are performed in a different order, and/or if components in a described system, architecture, device, or circuit are combined in a different manner, and/or replaced or supplemented by other components or their equivalents.

What is claimed is:

1. A method of simulating draping of fabric, comprising:
displaying user interface elements configured to indicate physical property parameters of the fabric;
receiving adjustment to at least a subset of the physical property parameters determined by manipulation the user interface elements by a user;
generating a mesh of the fabric draped on an object by applying the adjusted physical property parameters to a machine learning model trained using shapes of fabrics draped on the object and physical property parameters of the draped fabrics; and
displaying the fabric draped on the object according to the generated mesh.

2. The method of claim 1, wherein the machine learning model is a neural network model.

3. The method of claim 1, wherein generating the mesh of the fabric comprises:
determining a contour of the fabric by applying the adjusted physical property parameters to the machine learning model; and
configuring the mesh of fabric to extend to the determined contour of fabric.

4. The method of claim 3, wherein generating the mesh of the fabric further comprises:
generating a first portion of the mesh on an upper surface of the object;
generating a second portion of the mesh extending from the first portion of the mesh by a predetermined width; and
generating a third portion of the mesh extending from the second portion of the mesh to the contour.

5. The method of claim 1, further comprising storing correlation between the physical property parameters, wherein the adjustment to the at least the subset of the physical property parameters is constrained by the stored correlation.

6. The method of claim 5, wherein the stored correlation represents distribution of physical property parameters corresponding to the fabric.

7. The method of claim 5, wherein the stored correlation represents reduction in a number of dimensions of the physical property parameters associated with the fabric.

8. The method of claim 5, further comprising displaying a visual effect indicating violation of constraints on the physical property parameters as indicated by the stored correlation on the user interface elements responsive to the adjustment violating the constraints.

9. The method of claim 8, wherein the visual effect is shown on a pointer of a slide bar corresponding to the physical property parameters.

10. The method of claim 8, wherein the adjusted physical property parameters are limited according to the constraints.

11. The method of claim 1, wherein the physical property parameters comprise at least one of a stretch force parameter, a bending force parameter or a density parameter.

12. The method of claim 11, wherein the stretch force parameter comprises at least one of a weft stretch force parameter, a warp stretch force parameter or a shear force parameter.

13. The method of claim 11, wherein the bending force parameter comprises at least one of a weft bending force parameter, a warp bending force parameter, and a diagonal bending force parameter.

14. The method of claim 1, further comprising:
receiving fabric information from the user via the user interface elements; and
determining the physical property parameters corresponding to the received fabric information by applying the fabric information to a generative model for generating the physical property parameters.

15. The method of claim 14, further comprising:
representing fabric types on a graph with axes corresponding to a plurality of features; and
determining the fabric information according to the graph responsive to receiving a fabric type from the user.

16. The method of claim 15, wherein each of the fabric types is represented as a zone defined by ranges of the features indicated by the axes.

17. The method of claim 16, further comprising generating a detailed level of the fabric information on the fabric type responsive to receiving a user input indicating selection within the zone.

18. The method of claim 14, wherein the fabric information comprises at least one of a type of selected fabric, composition information of the selected fabric, and unit weight information of the selected fabric.

19. The method of claim 1, further comprising:
sending the adjusted physical property parameters to a server through a network; and
receiving the generated mesh from the server.

20. A non-transitory computer-readable storage medium storing instructions thereon, the instructions when executed by a processor cause the processor to:
display user interface elements configured to indicate physical property parameters of fabric;
receive adjustment to at least a subset of the physical property parameters determined by manipulation of the user interface elements by a user;
generate a mesh of the fabric draped on an object by applying the adjusted physical property parameters to a machine learning model trained using shapes of fabrics draped on the object and physical property parameters of the draped fabrics; and
display the fabric draped on the object according to the generated mesh.
